(19) United States
(12) Patent Application Publication
(10) Pub. No.: US 2014/0016799 A1
(43) Pub. Date: Jan. 16, 2014

(54) Host unit with docking headset

(71) Applicant: Rajendra Kumar, Sharon Center, OH (US)

(72) Inventor: Rajendra Kumar, Sharon Center, OH (US)

(73) Assignee: KHYBER TECHNOLOGIES CORPORATION, Sharon Center, OH (US)

(21) Appl. No.: 13/938,182

(22) Filed: Jul. 9, 2013

Related U.S. Application Data
(63) Continuation-in-part of application No. 12/134,517, filed on Jun. 6, 2008, now Pat. No. 8,483,755.
Application No. 12/134,517 is a continuation-in-part of application No. 12/133,980, filed on Jun. 5, 2008, now Pat. No. 8,600,437.
Application No. 12/133,980 is a continuation-in-part of application No. 11/539,373, filed on Oct. 6, 2006, now Pat. No. 7,831,276.
Application No. 11/539,373 is a continuation of application No. 11/305,996, filed on Dec. 19, 2005, now Pat. No. 7,120,462.
Application No. 11/305,996 is a continuation of application No. 09/719,290, filed on Dec. 7, 2000, now abandoned.
(60) Provisional application No. 60/128,138, filed on Apr. 7, 1999.
(60) Provisional application No. 61/684,894, filed on Aug. 20, 2012.

(51) Int. Cl. H04R 1/04

(52) U.S. Cl. CPC H04R 1/04
USPC 381/122

(57) ABSTRACT

A portable combination device, capable of delivering music and other audio messages including a host unit containing a front side and a circuit for producing audio messages and wireless representative signals of the audio messages; a headset containing a circuit for receiving the wireless representative signals and playing back the audio messages through an earbud, formed and sized to fit in a user's ear canal; and a docking mechanism for docking the headset onto the host unit such that a substantial part of the ear-bud protrudes beyond an edge of the host unit and is visible from the front of the host unit when docked, and the docking mechanism keeps the docking port on the host unit substantially recess-free.

### CROSS-REFERENCE TO RELATED APPLICATIONS

This application is a Continuation-in-Part of U.S. patent application Ser. No. 12/134,517, filed Jun. 6, 2008, which is a Continuation-in-Part of U.S. patent application Ser. No. 12/133,980, filed Jun. 5, 2008, which is a Continuation-in-Part of U.S. patent application Ser. No. 11/539,373 filed Oct. 6, 2006, which is a continuation of U.S. patent application Ser. No. 11/305,996 filed Dec. 19, 2005, now U.S. Pat. No. 7,120,462; which is a continuation of U.S. patent application Ser. No. 09/719,290, filed Dec. 7, 2000 now abandoned; which was a National Stage Entry of PCT/US00/09188 filed Apr. 7, 2000, which claimed the benefit of U.S. Provisional Application Ser. No. 60/128,138 filed Apr. 7, 1999. This application also claims the benefit of U.S. provisional patent application Ser. No. 61/684,894, filed Aug. 20, 2012, The entire specifications of all of these applications are incorporated herein by reference.

### BACKGROUND

This invention generally relates to computing equipment. More particularly, the invention relates to personal computing, communications and entertainment devices. Specifically, the invention relates to a personal computing, communication and entertainment device that includes at least one docking port designed to receive and retain a complementary hands-free headset therein.

To address consumers' portable computing, mobile communications, and portable entertainment needs, a variety of portable devices have been developed. The distinctly differing requirements of each application have made it too costly and unwieldy for such devices to fulfill more than one type, or two closely related types of need.

For example, smart cell phones are devices that combine the capabilities of cell phones and electronic organizers. Typical of such devices are the Model PDQ-800 from Qualcomm, Inc. of San Diego, Calif., and the Model R380 from Ericsson, Inc. of Richardson, Tex. These products perform quite well as handheld computing and communication devices by allowing the user to access the Internet for email, stock quotes, etc. while preserving their use as simple wireless phone units. However, in order to allow handheld grasping, these units had to be kept small, thereby limiting their display to a size that is too small for practical use in conventional computing such as Web browsing, word processing, etc. Also, to keep the cost of such devices low, their designers employed central processors that have just enough power to carry out smart phone functions, and not enough power to handle general computing requirements.

Recently, Motorola, Inc. of Schaumburg, Ill. has begun to sell its clipOn Organizer as an attachment to its StarTAC cellular telephone and to provide it with smart phone functionality. The clipOn Organizer and StarTAC phone have been designed to operate as individual, stand-alone units, each furnishing its own processor and power supply. Consequently, attaching the units does not achieve the reduced size or cost desired in an integrated combination.

For portable computing, the industry provides conventional laptop computers, such as those based on Pentium processors from Intel Corporation of Santa Clara, Calif. and Windows software from Microsoft Corporation of Redmond, Wash., and mini-laptop computers, such as Microsoft WindowsCE based devices, called Handheld Personal Computers (HPCs). The industry has also furnished palm-sized devices for personal information management and organization such as the Palm Pilot from 3Com Corporation of Santa Clara, Calif., and Microsoft WindowsCE-based palm-sized PCs.

To fulfill the portable entertainment needs of consumers, the computer industry provides digital audio players, such as the Diamond Multimedia Rio model made by S3, Inc. of Santa Clara, Calif. that plays MP3 compatible audio content downloaded from the Internet. Another portable entertainment device is the wireless system controller for home entertainment systems provided by Harmon/Kardon International of Woodbury, N.Y.

To fulfill both mobile computing and communication needs, a mobile user has to carry two, and sometimes three devices, such as a smart phone unit, an organizer, and a laptop unit. Of course, if entertainment is also desired, the user must carry yet another device, the MP3 player. The user has to purchase and maintain multiple units, charging multiple sets of batteries, and synchronizing data from one with that of the other.

Additionally, hands-free or wireless headsets are commonly used by operators of computers, smartphones, cell phones, MP3 players and the like. As technology advances, these headsets are being manufactured in increasingly smaller and more compact versions. Since the headsets are not linked physically to the computing, communication and entertainment devices, one of the problems a user has is what to do with the headset when it is not in use. Additionally, the headsets need to be recharged periodically. This is typically done by connecting the headset to a power supply, such as an AC power supply, by using a power cord and transformer. This power cord adds yet another set of recharging equipment to individuals, households and businesses.

There is therefore, a need in the art for an improved way to store and recharge hands-free headset units.

Further, the Wireless Telecom industry provides headsets generally having a stubby ear bud and a narrow arm. The ear bud contains a tiny speaker and the arm contains a microphone. The industry also provides host units in popular form-factors such as mobile phones, laptop computers, and tablet computers and the like.

Recently, the industry has introduced combinations of headsets host units, where the headset is docked onto the host unit when not in use. In some cases, the headset is charged while docked to the host unit. Some examples of such combination devices are given below.

For example, LG model Decoy, introduced in 2008, included a headset in a popular form-factor, docking into a recessed portion of a mobile phone of modified form-factor. The product was later discontinued without any succession. This device generally relied upon a recessed docking port for the headset. This tended to make the host unit form-factor considerably odd compared to other host units and thereby difficult to implement in successive products.

For another example, Newton Peripheral model MoGo Headset which was introduced in 2009, includes a headset of ultra-low profile, docking into a recessed portion of a cradle that adds onto certain smartphones. Again, this product employs an odd shaped headset having a totally new and untried form factor from previous form factors.

In each of the above described prior art, the combination of the docking headset and host unit either employed a peculiar form factor for the headset or for the host unit. Consequently, to date, no combination device has achieved a mass-market acceptance.

Thus, there is a need for a mechanism that will enable selected headsets of conventional shapes to dock onto mating host units of conventional shapes.

### SUMMARY

In one embodiment, the device of the present invention comprises a display unit that includes at least one docking port for receiving and retaining a complementary hands-free headset therein. The docking port comprises a recessed slot formed in the housing of the display unit. The headset preferably is frictionally retained within the docking port. Additionally, the docking port is provided with a power jack connector that matingly engages a complementary power jack on the headset. Consequently, when the headset is engaged in the docking port, power is fed from the display unit to the headset to recharge the rechargeable power supply within the same. The display unit can take a variety of forms including a laptop-type computing device that includes a central processing unit; a laptop-type device that has an additional docking station for receiving a portable computing device therein; or a portable computing device such as a smartphone.

In another embodiment, a portable combination device, capable of delivering music and other audio messages includes: a host unit containing a front side and a circuit for producing audio messages and wireless representative signals of the audio messages; a headset containing a circuit for receiving the wireless representative signals and playing back the audio messages through an ear-bud, formed and sized to fit in a user's ear canal; and a docking mechanism for docking the headset onto the host unit such that a substantial part of the ear-bud protrudes beyond an edge of the host unit and is visible from the front of the host unit when docked, and the docking mechanism keeps the docking port on the host unit to be substantially recess-free.

In a further embodiment, a combination device as described above also includes an adapter module mounted on the host unit and having the docking mechanism integrated on it.

Various aspects will become apparent to those skilled in the art from the following detailed description and the accompanying drawings.

### BRIEF DESCRIPTION OF THE DRAWINGS

FIG. 1 is a perspective view of an exemplary device in accordance with the present invention for mobile computing, communication and entertainment. This view presents a front perspective view of a detachable handset unit and a top perspective view of a clamshell shaped docking display unit having a partially open lid and base, and illustrates diagrammatically how exemplary electrical connectors in each unit may engage and mate so that the units form a single combined device;

FIG. 2 is a cross-section elevational view of the exemplary device shown in FIG. 1 with the detachable handset unit mated with the docking display unit;

FIG. 3 is an exemplary block diagram of the device shown in FIG. 1;

FIG. 4 is a rear perspective view of the detachable handset unit;

FIG. 5 is a side elevational view of the device shown in FIG. 1 when mounted in a vehicle and in an operational configuration;

FIG. 6 is a perspective view of a second embodiment of a portable computing, communication and entertainment device in accordance with the present invention;

FIG. 7 is an enlarged front view of the detachable portable device shown in a partially docked position with the docking display unit;

FIG. 8 is a cross-sectional side view of the detachable portable device and docking display unit taken through line 8-8 of FIG. 7;

FIG. 9 is a perspective view portable device showing the detachable portable device completely disengaged from the docking display unit;

FIG. 10 is a perspective view of a personal computing device including at least one docking port for receiving a hands-free headset therein and showing the hands-free headset docked therein;

FIG. 11 is an enlarged top view of the docking port with the hands-free headset docked therein;

FIG. 12 is a cross-sectional front view through line S-S of FIG. 11;

FIG. 13 is a perspective view of the personal computing device showing a pair of hands-free headsets disengaged from the device and showing the docking ports in the computing device;

FIG. 14 is a front perspective view of an alternative embodiment of a personal computing device in accordance with the present invention and including at least one docking port for receiving a hands-free headset unit therein;

FIG. 15 is a rear perspective view of the alternative embodiment of the personal computing device showing the hands-free headset unit docked in the docking port;

FIGS. 16 A, B, and C illustrate a front, a side, and a rear view of a portable combination device;

FIG. 17 shows a detailed view of the headset of FIGS. 16 A, B, and C; and

FIG. 18 shows a detailed view of the adapter module of FIGS. 16 A, B, and C.

### DETAILED DESCRIPTION

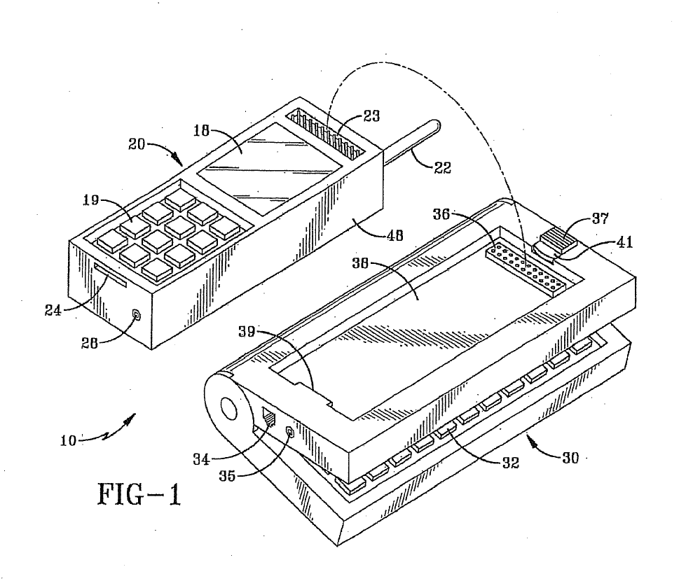

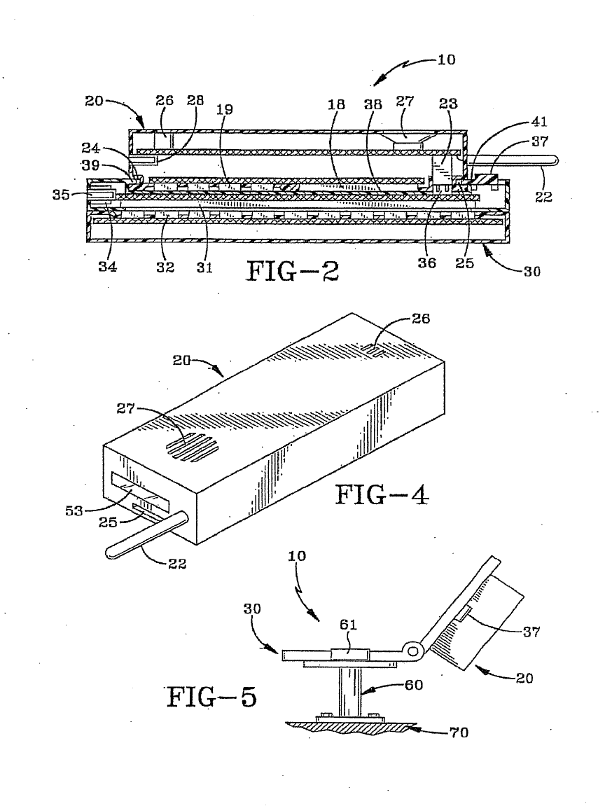

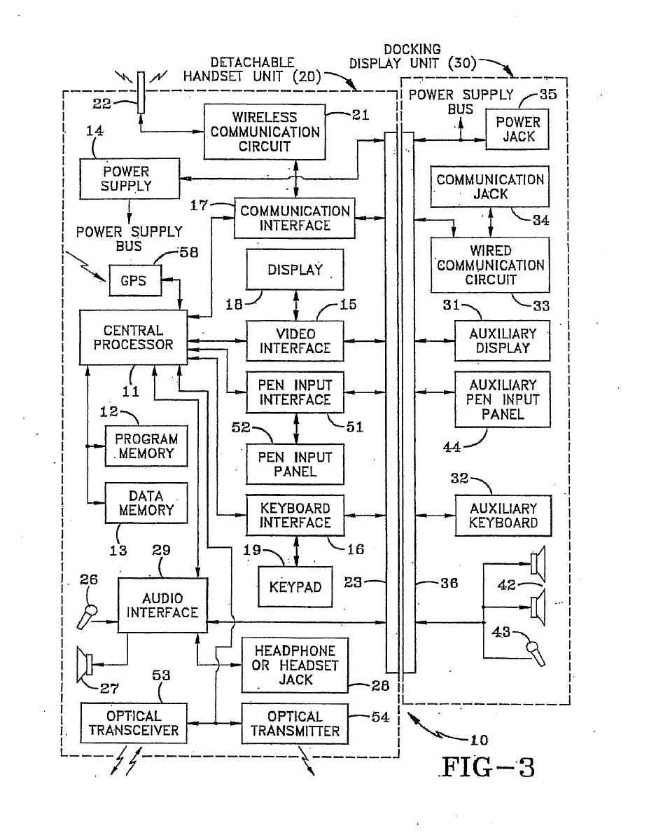

One embodiment of an exemplary device in accordance with the present invention for mobile computing, communication, and entertainment is illustrated in FIGS. 1 through 4 and generally indicated by the numeral 10. Device 10 includes a detachable handset unit 20 and a docking display unit 30.

Detachable handset unit 20 may also include an electrical connector 23 that carries signals from the central processor 11 through video interface 15, keyboard interface 16, communication interface 17, pen-input interface 51, audio interface 29, and power supply 14. As seen in FIG. 3, the docking display unit 30 does not include a central processor, and one or more of the circuits in the docking display are operated by the central processor 11 of the detachable handset unit. Mating electrical connector 36 in docking display unit 30 may therefore connect these signals to auxiliary display 31, auxiliary keyboard 32, wired communication circuit 33, auxiliary pen-input panel 44, speakers 42 and microphone 43, and power-jack 35. Communication circuit 33 is connected to communication jack for further connection to communication lines such as the public switched telephone network or cell or other wireless network.

Docking display unit 30 includes a recessed platform 38, with an electrical connector 36, a fixed tab 39 and a movable tab 41, retractable by a latch 37. To dock detachable handset unit 20 into docking display unit 30, fixed tab 39 is slid into slot 24 with the front side of detachable handset unit 20 facing platform 38. The other end of detachable handset unit 20 is brought down to have connector 23 on detachable handset unit 20 mate with connector 36 of docking display unit 30. Tab 41 is slid into slot 25 to secure detachable handset unit 20 in place.

Docking display unit 30 is shown as a clamshell style unit, including an auxiliary display 31, in the lid portion and an auxiliary keyboard 32 in the base portion, facing each other in the closed position. The lid of docking display unit 30 also contains a communication jack 34 such as a standard RJ-style telephone jack, and a power jack 36, such as an AC adapter/charger jack.

The block diagram in FIG. 3 shows detachable handset unit 20 including a central processor 11, and the circuits supported and/or controlled by it, namely program memory 12, at memory 13, power supply 14, video interface 15, keyboard interface 16, communication interface 17, pen-input interface 61, and audio interface 29. In turn, video interface 15 drives display 18, the keyboard interface 16 drives the keypad 19, communication interface 17 drives wireless communication circuit 21, pen-input interface 51 drives the pen-input panel 52, and audio interface 29 drives microphone 26 and speaker 27, and connects to the headphone jack 28. Wireless communication circuit 21 is connected to the antenna 22. GPS receiver 58, such as that supplied by SiRF Technology of San Jose, Calif., is also connected to central processor 11.

Detachable handset unit 20 also includes an electrical connector 23 that carries signals from the central processor 11 through video interface 15, keyboard interface 16, communication interface 17, pen-input interface 51, audio-interface 29, and power supply 14. Mating electrical connector 36 in docking display unit 30 connects these signals to auxiliary display 31, auxiliary keyboard 32, wired communication circuit 33, auxiliary pen-input panel 44, speakers 42 and microphone 43, and power-jack 36. Wired communication circuit 33 is connected to communication jack 34 for further connection to external wired communication lines such as the public switched telephone network.

Detachable handset unit 20 may also contain an optical transmitter 54 for transmission of remote control signals to TV, VCR, etc. Alternately, it may be equipped with an optical transceiver 53 for optical communication with other compatible devices such as laptop computers, printers and network interfaces.

In another variation of the above embodiment of the interface signals connecting the circuitry carried in detachable handset unit 20 and docking display unit 30 may be multiplexed using conventional multiplexing circuits, in order to reduce the number of interconnect signals and hence reducing the size of connectors 23 and 36.

In another variation of the above embodiment, detachable handset unit 20 may contain no display at all, like conventional cordless handsets. In this case, central processor 11 will still drive the auxiliary display 31 through the video interface 15, and video interface 15 may be housed in docking display unit 30, further reducing the size of detachable handset unit 20.

FIG. 5 shows docking display unit 30 mounted on the floor of a vehicle 70. The bottom end of a pedestal 60 is attached to the vehicle floor 70. Clamps 61 are attached to the top end of pedestal 60. Docking display unit 30 can be removably mounted on pedestal 60 using bolts or other conventional methods. Detachable handset unit 20 can then be docked in docking display unit 30 in the same manner as in other applications described herein.

An artisan of ordinary skill should now appreciate that in this way a portable device for computing, communication and/or entertainment can be created that has a detachable handset unit. When mated with a docking display unit, the detachable handset unit becomes the controller for the entire portable computing, communication and entertainment device. The detachable handset unit is in a smaller housing that is dimensioned for handheld grasping, and is sized to be carried in a pocket like an average cell phone. The docking display unit carries an auxiliary, larger display and other components. The central processor, carried in the detachable handset unit, and being used to operate the docking display unit, must have enough processing power to adequately perform functions of an entire portable computing, communication and entertainment device, and not just the function of a wireless phone. Examples of commercially available processors adequate for this task include the Intel StrongARM processor, the models SH-3 and SH-4 processors from Hitachi American, Ltd. of Brisbane, Calif., and the model 4100RISC processor from NEC America, Inc. of Irving, Tex.

As technology advances in the future, the Pentium processor from Intel, used in most laptop computers, may be used in other embodiments of the current invention. The other components used in device 10 can be similar to those employed by traditional computing devices, communication devices and entertainment devices. Typical of these other components are: liquid crystal displays of small and large sizes from Optrex America Inc. of Detroit, Mich., and Seiko Instruments USA, Incorporated of Torrance, Calif.; memory chips from Micron Technologies, Inc. of Boise, Id., VLSI Technologies wireless communication chips available from Philips North America in Atlanta, Ga., power supply chips from Analog Devices Inc. of Norwood, Mass., and pen-input panels from MicroTouch Systems, Inc. of Methuen, Mass.

Device 10 as described herein will require operating system software such as Microsoft Windows or WindowsCE. Off-the-shelf application software such as Microsoft Outlook, PocketWord, etc., can be used for various tasks. Alternately, the Java software platform from Sun Microsystems, Inc. of Palo Alto, Calif., can be implemented in device 10. In this instance, Java applets can be downloaded onto device 10 from the Internet via wireless communication circuit 21 or via wired communication circuit 33.

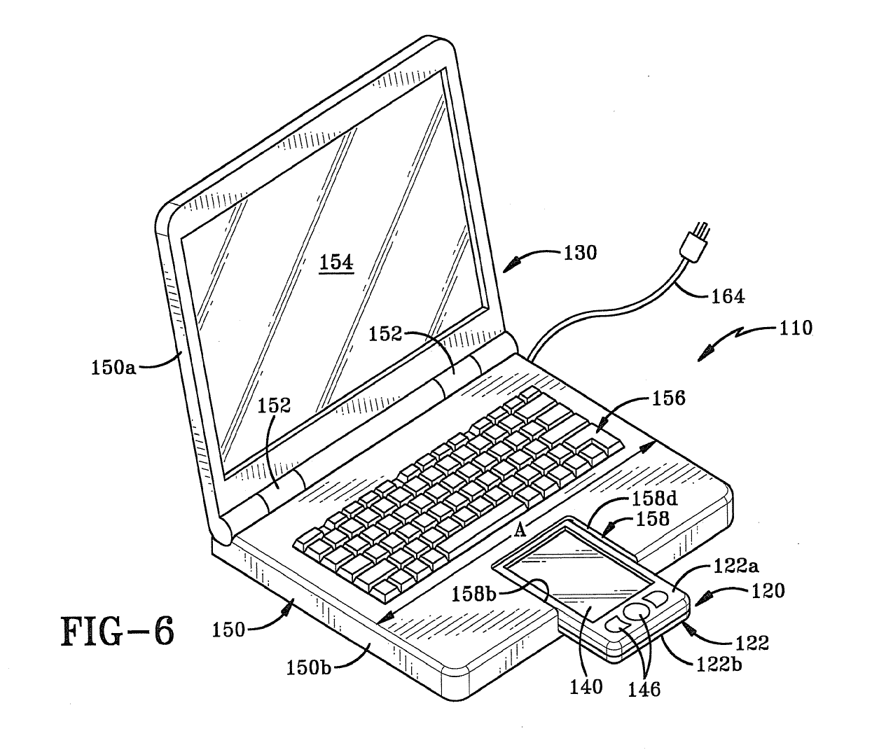

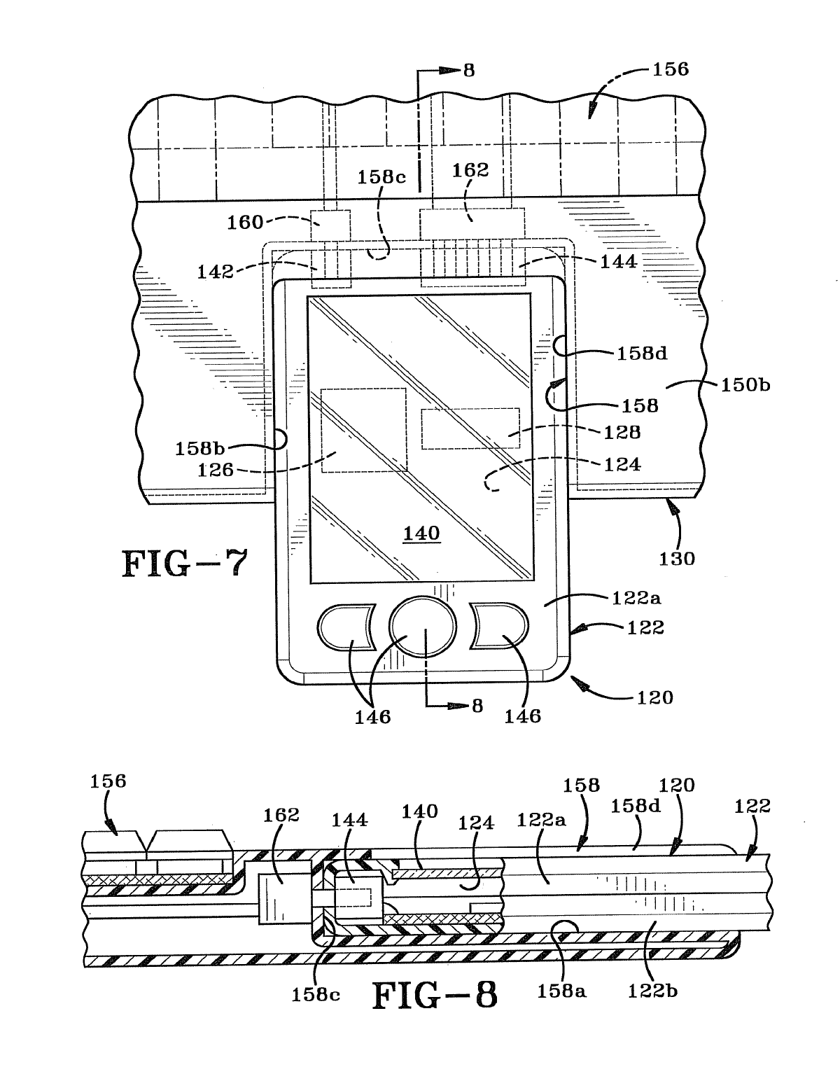

Referring to FIGS. 6-9, there is shown a second embodiment of a portable device for computing, communication and/or entertainment, said device being generally indicated by the numeral 110. Device 110 comprises a detachable portable device 120 and a docking display unit 130.

Detachable portable device 120 is contemplated to be any portable electronic device that a user may select to provide a range of computing, communication and entertainment applications. Preferably, portable device 120 is a smartphone that is used for such applications. Examples of smartphones suitable for use as portable device 120 include the i900 smartphone made by Samsung Electronics Co. Ltd. of the Republic of Korea, or the Portege G810 made by the Toshiba Corporation of Tokyo, Japan. These smartphones have a wide range of capabilities beyond being useful as a phone. They permit the user to browse the Internet, send and receive text messages, act as navigation devices, organize personal information, have media players that may be used to play music, view videos, take and transmit photographs, and may be used for reading documents in various formats and used for gaming, to name but a few applications. These devices preferably include a touchscreen for user interface, but may additionally be provided with a keyboard and directional pads for gaming. They are preferably, but not necessarily, designed for wireless communication. It will be understood that any type of smartphone or portable personal communication device may be utilized in the present invention without departing from the spirit thereof.

Portable device 120 includes a housing 122 having a top 122a and a bottom 122b that are secured together. Top 122a and bottom 122b define an interior cavity 124 within which is retained a variety of components that enable the device to be used for all of the above-named applications. Specifically, portable device 120 includes a central processing unit 126 and a rechargeable power supply 128 for powering the same. Both the central processing unit 126 and power supply 128 are retained within cavity 124. Top 122a of housing 122 is provided with a touchscreen 140 that acts as a primary user interface for the device. A housing is also provided with a power jack 142, one or more communication jacks 144, and control buttons 146 for switching the device on and off etc. Although not illustrated for the sake of clarity, housing 122 further contains circuitry therein that links the various components to power supply 128 so that the various components may be powered thereby. Portable device 120 is designed to be easily grasped in the hand and is of a size that preferably will permit the user to slip the same into a pocket in their clothing.

In accordance with a specific feature of the present invention, display unit 130 is designed and manufactured to be complementary to a specific portable device 120 and to act as a docking station for the same. Consequently, different portable devices will be designed to dock with their own specially designed docking display units 130. The display unit 130 in accordance with the present invention preferably is a notebook-type device having the external appearance of a laptop computer. Display unit 130 may be a device that includes a central processing unit or may be a device that is devoid of a central processing unit and is merely a shell. Preferably, display unit 130 has the configuration of a laptop computer, but it will be understood that a desktop computer could also incorporate a docking port for physically engaging a portable device 120 therein.

In accordance with a specific feature of the present invention, display unit 130 comprises a housing 150, preferably of a clamshell type, having a first region 150a and a second region 150b secured together by a hinge 152. Preferably, first region 150a includes a display screen 154, such as a liquid crystal display screen, and second region 150b includes a keyboard 156. First region 150a is foldable onto second region 150b when the device is not in use or needs to be transported. Display unit 130 does not include a touch pad or track pad for user interface. Display unit 130 does, however, include circuitry (not shown) that operationally connects a power jack connector 160 and a communication jack connector 162 to display screen 154, keyboard 156 and rechargeable power supply (not shown). However, unless and until, portable device 120 is engaged with display unit 130, as will be hereinafter described, these circuits remain open, and neither the keyboard 156 nor the display screen 154 can be activated. When portable device 120 is docked in display unit 130, the power supply in the portable device 120 is recharged by the power supply in the display unit 130. Display unit 130 is also connectable via a power cord 164 and AC/DC adapter (not shown) to a remote AC power source to recharge the power supply in the display unit 130. If the display unit 130 is connected to the remote AC power source when portable device 120 is docked therewith, the remote AC power source will recharge the power supply in the portable device 120. The rechargeable power supply in display unit 130 also powers functions such as lighting the display screen 154 when portable device 120 is docked with display unit 130.

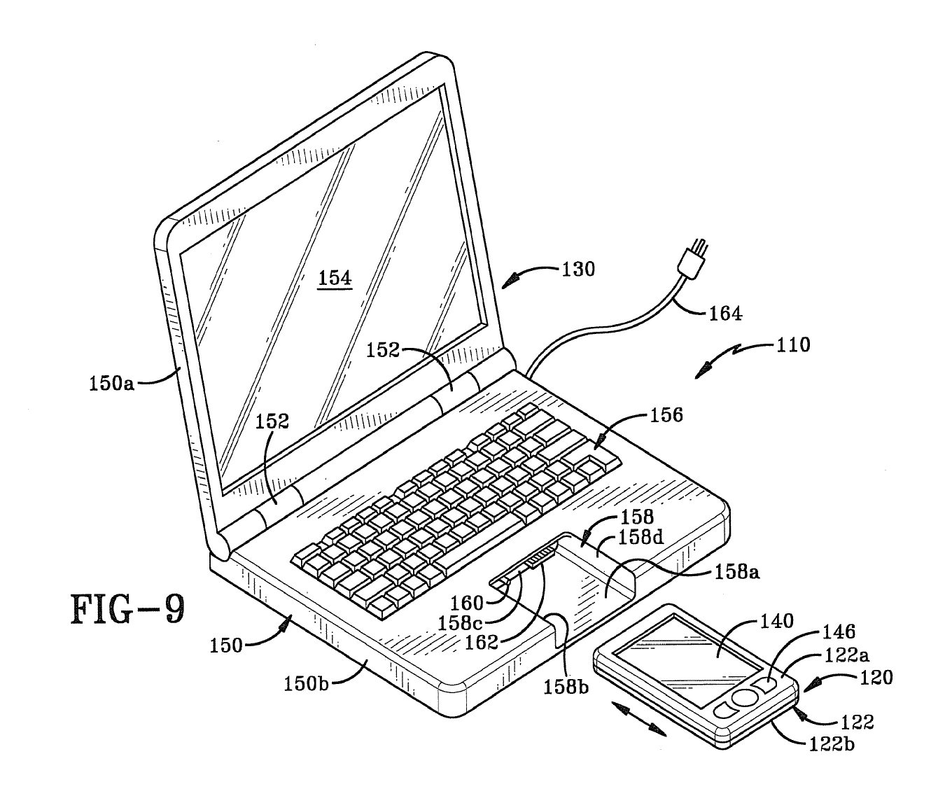

In accordance with a specific feature of the present invention and as shown in FIG. 9, second region 150b of housing 150 defines a docking port 158 therein. Docking port 158 preferably is disposed in a location adjacent keyboard 156 and in a region where a touchpad for a conventional laptop computer would normally be located. In the attached FIGS., docking port 158 is situated in the middle of the front edge of second region 150b and docking port 158 is oriented substantially at right angles to the length “A” of the front edge. Docking port 158 is therefore designed to receive a portable device 120 that will be disposed at right angles to the front edge of the second region 150b. It will be understood, however, that docking port 158 may alternatively extend inwardly from a side edge of second region 150b and be disposed substantially parallel to the length “A” of second region 150b. The portable device that is received in this alternatively oriented docking port will be inserted into said docking port at right angles to the side edge thereof.

Referring to FIGS. 6-9, docking port 158 is recessed into the external surface of the front edge of second region 150b and at right angles to length “A”. Docking port 158 is defined by a bottom wall 158a and a peripheral wall extending upwardly therefrom. Peripheral wall comprises side walls 158b, 158c, and 158d. Side wall 158b originates in the front edge of second region 150b and side wall 158d terminates in the front edge thereof. Consequently, side wall 158b is spaced a distance away from side wall 158d and a gap is defined therebetween. This gap, which is disposed opposite side wall 158c, constitutes a slot into which portable device 120 is insertable. A power jack connector 160 and a communications jack connector 162 are provided on side wall 158c. Power jack connector 160 and communications jack connector 162 may be recessed into side wall 158c or may extend outwardly from side wall 158c and for a short distance over bottom wall 158a. Connectors 160, 162 are disposed in positions where they will be engageable with power jack 142 and communications jack 144 on portable device 120. The exact positions of power jack connector 160 and communications jack connector 162 are determined by the type of portable device 120 that is to be docked in docking port 158. As shown in FIG. 8, a small region of the upper wall of second region 150b extends outwardly beyond side wall 158c and for a short distance over bottom wall 158a. This small region acts as a guide for proper seating of portable device 120 in docking unit 130. It also protects power jack connector 160 and communications jack connector 162 from accidental impact.

Portable device 120 is docked with display unit 130 by inserting portable device 120 into the gap formed between side walls 158b, 158d and into docking port 158 (FIG. 9). Care must be taken to ensure that the correct leading edge of portable device 120 is inserted first into docking port 158, the correct leading edge being the side on which the power jack 142 and communications jack 144 are provided. The bottom 122b of housing 122 of portable device 120 is slid along the bottom wall 158a of docking port 158. As portable device 120 slides along bottom wall 158a of docking port 158, the leading edge slides under the lip formed by the upper wall of second region 150b and power jack 142 engages power jack connector 160 and communications jack 144 engages communications jack connector 162. As shown in FIGS. 6-9, docking port 158 preferably is oriented substantially at right angles to the length “A” of display unit 130. This orientation places touchscreen 140 and control buttons 146 in a suitable position for easy activation by the user. The orientation of portable device 120 also ensures that the portion of portable device 120 including touchscreen 140 has a solid base under it in the form of bottom wall 158a. Consequently, any downward pressure on touchscreen 140 will not result in a downward rotation of portable device 120 that would cause power and communications jacks 142, 144 and power and communication jack connectors 160, 162 to disconnect. The small lip of the upper wall of second region 150b that extends over the front edge of portable device 120 also aids in preventing downward rotation of portable device 120.

Once portable device 120 is engaged in docking port 158 and is thereby fully docked into display unit 130, the central processing unit 126 of portable device 120 becomes the brain of display unit 130 and is able to control the display screen 154 and keyboard 156. Portable device 120 is provided with all of the software that switches the user interfaces as necessary between touchscreen 140 and keyboard 156 and is used to drive both portable device 120 and display unit 130 when they are operationally connected together. The results of the activation and manipulation of touchscreen 140 and keyboard 156 are displayed on display screen 154 of display unit 130. Display unit 130 effectively acts as a device for enlarging the display of portable device 120 which would typically only be viewable only on touchscreen 140. Display unit 130 also makes it easier for the user to type text using the full size or almost full size keyboard 154, thus making it easier to input data into portable device 120. Although not specifically illustrated herein, display unit 130 may also be provided with speakers or with a connection to external speakers that can enhance the audio output from portable device 120. Consequently, when portable device 120 is docked with display unit 130, the output from portable device 120, whether visual or auditory, is enhanced.

When the user no longer needs the enlarged display screen 154 and keyboard 156, they slide portable device 120 out of docking port 158. This action deactivates display unit 130 causing it to revert to being merely a shell. Display unit 130 may then be folded up for transportation or storage as previously described. The user will dock portable device 120 with display unit 130 when full notebook functionality is required. When full notebook functionality is no longer required, portable device 120 will be detached from display unit 130. Portable device 120, once fully detached from display unit 130 is useful as the small handheld computing, communication and entertainment device it was manufactured to be.

Device 110 is an electronic device that comprises a first docking portion, being display unit 130, which has a housing with a first set of electronic circuits that provide a first set of functions. The housing defines a recessed docking port therein. Device 110 further comprises a second portable electronic device, portable unit 120, which has a housing, at least a region of which is complementary shaped to fit into the recessed docking port. The portable unit 120 has a second set of electronic circuits that perform a second set of functions. The portable unit 120 is physically docked into the display unit 130. A communications port connects the display unit 130 and portable unit 120 so that the first and second sets of electronic circuits are operationally connected. In the attached FIGS., the communications port comprises one or more jacks on the portable unit 120 and complementary connectors on the display unit 130. It will be understood, however, that the communications port could comprise a wireless connection between the first and second sets of electronic circuits in the display unit 130 and portable unit 120. The communications port enables communication between the first set of electronic circuits and the second set of electronic circuits such that when portable unit 120 is physically engaged in a docking port, display unit 130 takes on the second set of functions.

Docking port 158 is recessed into the second region 150b of the docking unit 130 and the gap between side walls 158b, 158d opens at the edge of second region 150b. Consequently, portable unit 120 may be slidably inserted into this gap when first region 150a is in a folded or closed position (not shown) relative to second region 150b, or is in an open position relative thereto, such as is illustrated in the attached FIGS.

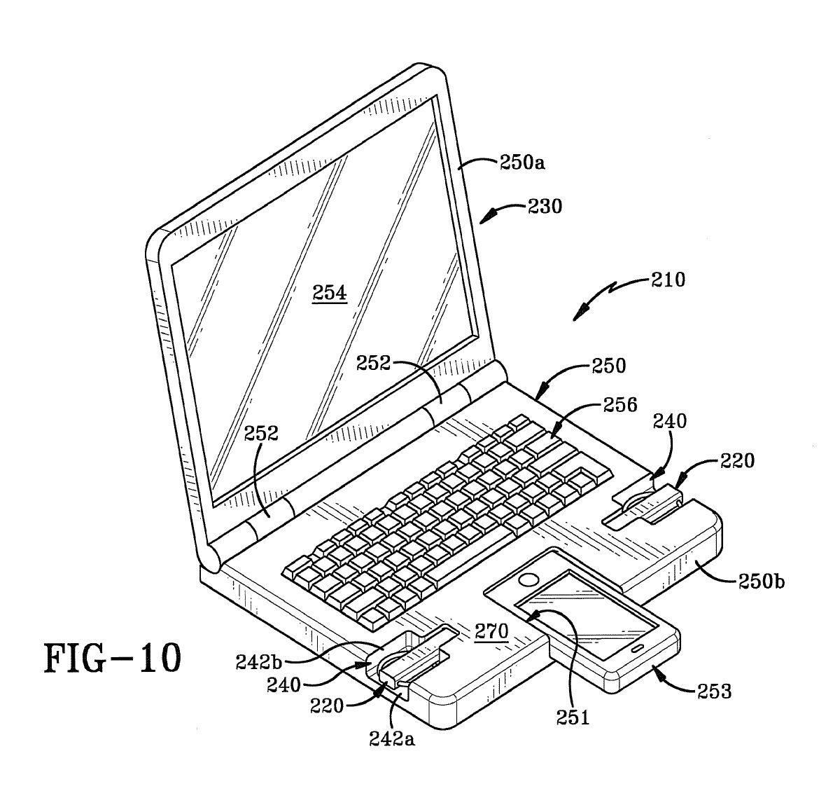

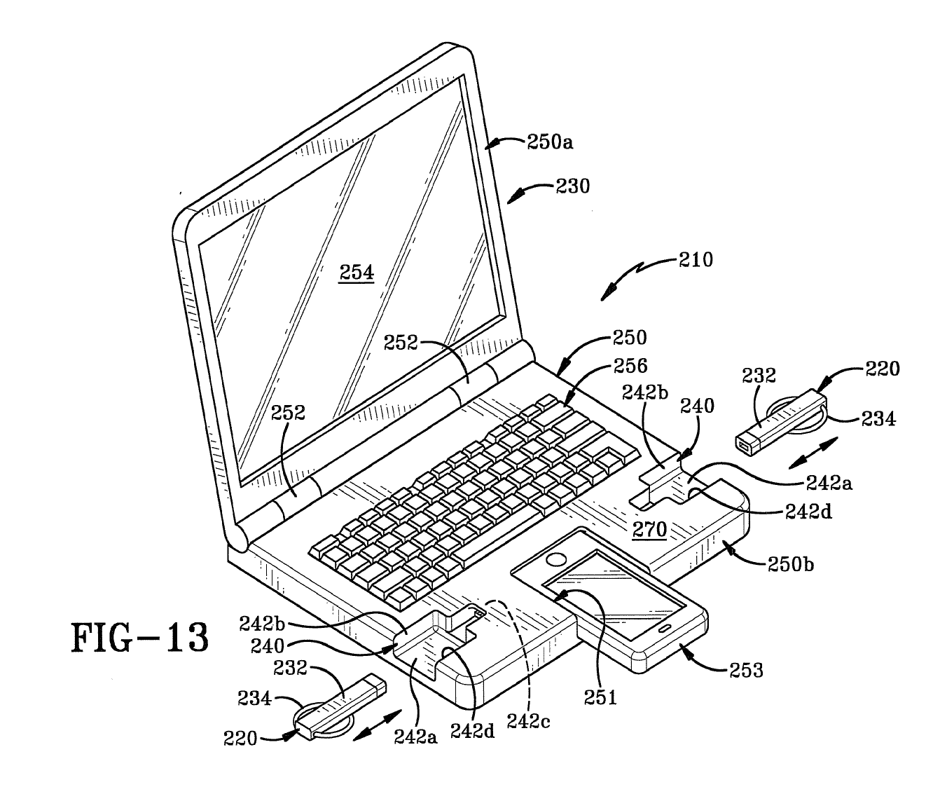

Referring to FIGS. 10-15, there is shown a personal computing device in accordance with the present invention. The computing device is useful for computing, communication and/or entertainment applications and is generally indicated by the numeral 210. Device 210 comprises a detachable hands-free operation type of headset unit 220 and a docking display unit 230. Docking display unit 230 includes a docking port 240 that is complementary configured to receive and retain headset unit 220 therein.

Detachable headset unit 220 is a hands-free operation headset, i.e., a wireless headset, that is useful for listening to any type of music, audio clips, phone conversations and the like that are transmitted from or played on display unit 230. Suitable types of headset units 220 include Bluetooth® compatible hands-free operation headsets such as the Jabra BT5020 Bluetooth cell phone headset manufactured by Jabra Corporation of San Diego, Calif. or the Motorola H500 manufactured by Motorola, Inc. of Schaumburg, Ill. (Bluetooth is a registered trademark of Bluetooth Sig, Inc. of Bellevue, Wash.)

Headset unit 220 comprises a housing 232 having an earpiece 234 extending outwardly therefrom and being configured to be engaged on the earlobe of a user. Headset unit 220 has a built-in power jack 236 and an internal power supply 238. The specifics of the shape and style of headset unit 220 are dependent on the design thereof and are not material to the present invention other than that they dictate the complementary configuration of docking port 240 on display unit 230.

Referring to FIGS. 10-13, there is shown a first exemplary display unit 230 that may incorporate the docking port 240 and engage the headset unit 220 therein. Display unit 230 is a laptop computing device or notebook type of computing device having a housing 250 that is preferably of a clamshell type. Housing 250 includes a first region 250a and a second region 250b that are secured together by a hinge 252. First region 250a may be pivoted into abutting contact with second region 250b when display unit 230 is not in use, and may be pivoted out of contact with second region 250b when display unit 230 is to be used. Preferably, first region 250a includes a display screen 254, such as a liquid crystal display screen, and second region 250b includes a keyboard 256. The computing and communication device 210 shown in these FIGS. is preferably of the type shown in FIGS. 6-9. However, display unit 230 includes an additional docking port 251 within which a portable computing device 253, such as a smartphone, may be selectively docked. When the portable computing device 253 is docked in docking port 251, the touchscreen 255 of portable computing device 253 becomes a user interface for display unit 230. Portable computing device 253 includes a central processing unit that acts as the brain for the combined computing and communication device 210.

In accordance with a specific feature of the present invention, display unit 230 includes at least one docking port 240 configured to selectively receive and retain headset unit 220 therein. Display unit 230 may, as shown in the attached FIGS., include a pair of docking ports 240 therein, each docking port 240 being configured to receive a separate headset unit 220 therein. Docking port or ports 240 may be located anywhere on display unit 230 without departing from the spirit of the present invention. Although not illustrated in the attached FIGS., a single docking port may, alternatively, be configured to receive a pair of headset units therein, with said pair of units being disposed in a side-by-side configuration or one over the other. Furthermore, while docking ports 240 are shown in FIG. 10 to permit headset units 220 to be slidably inserted from the side edge of display unit 230, it will be understood that docking port 240 may be a shaped recess formed in one of the first and second regions 250a, 250b that is not accessible from any of the side edges of either of the first and second regions 250a, 250b.

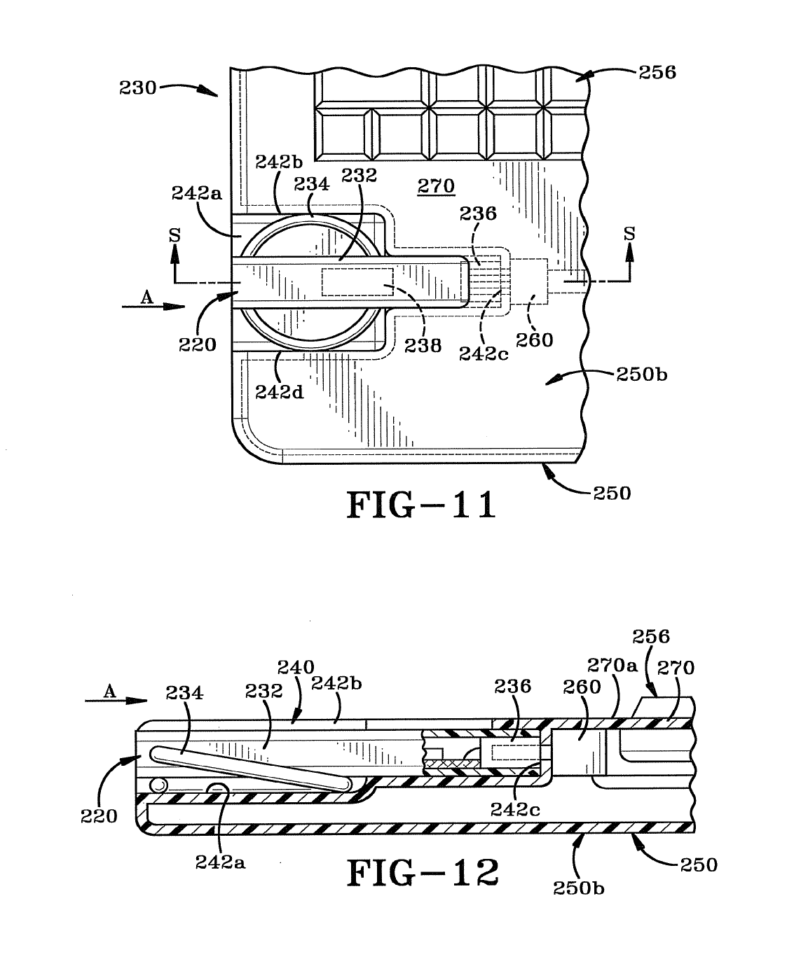

As illustrated in the attached FIGS., docking port 240 is designed to be complementarily configured to a particular headset unit 220 and to act as both a storage location and a power supply recharging station for the same. Docking port 240 is recessed into second region 250b of the housing 250 of display unit 230 adjacent keyboard 256 and spaced a distance from docking port 251. Referring to FIGS. 11 and 12, docking port 240 includes a bottom wall 242a and side walls 242b, 242c, 242d. Preferably, the portion of docking port 240 opposite side wall 242c is open so that headset unit 220 may be slidably inserted therein and removed therefrom. A power jack connector 260 is provided in one of the side walls, such as side wall 242c. The exact position of power jack connector 260 is dictated by headset unit 220. Connector 260 may be recessed into side wall 242c or may extend outwardly therefrom for a short distance over a portion of bottom wall 242a, and is positioned where it will be easily engageable with power jack 236 on headset unit 220. Display unit 230 includes a set of circuits (not shown) that operationally connect power jack connector 260 to the central processing unit (not shown) within display unit 230. Display unit 230 includes a power supply (not shown) that is operationally connected into the set of circuits to provide power to both display unit 230 and headset unit 220 when docked therewith. Consequently, when headset unit 220 is docked in docking port 240, the power supply 238 therein is recharged. Display unit 230 also includes transmitters (not shown) that wirelessly transmit auditory signals to headset unit 220.

Headset unit 220 is docked with display unit 230 by sliding the housing 232 thereof along bottom wall 242a of docking port 240. Headset unit 220 is slid inwardly until preferably no part thereof extends outwardly beyond the side wall 230a (FIG. 11) of display unit 230. Furthermore, docking port 240 is of a depth that is sufficient so that headset unit 220 does not project outwardly beyond outer surface 270a of the wall 270 of housing second region 250b of housing. Consequently, when first region 250a is pivoted into a closed position onto second region 250b, first region 250a does not directly contact headset unit 220 and thereby potentially cause damage to the same. It will be understood that docking port 240 is designed so that headset unit 220 is frictionally engaged therein. It is contemplated however that other means of securing might be provided to retain headset unit 220 within docking port 240. The design of docking port 240 also ensures that a solid base is provided under headset unit 220 in the form of bottom wall 242a. Consequently, any downward pressure on headset unit 220 will not result in a downward rotation thereof in a manner that would cause power jack 236 and power connector 260 to disengage or become damaged.

Headset unit 220 is engaged in docking port by inserting the power connector end thereof into the open region opposite side wall 242c. Headset unit 220 is slid inwardly into docking portion along bottom wall 242a in the direction of arrow “A” until power connector 236 is interlocked and becomes engaged in power jack 260. As power connector 236 engages power jack 260, electrical current flows through the same and into the circuitry within headset unit 220, thereby leading to a recharging of the power supply 238 within headset unit 220. Headset unit 220 is stored in this position until the user wishes to use headset unit 220 to listen to some type of audio input. When needed, the user slides headset unit 220 outwardly from docking port 240 by engaging the same with one or more fingers and moving the headset unit 220 in the opposite direction to arrow “A”. Power jack 236 disengages from power connector 260 and headset unit 220 may then be slid outwardly or lifted outwardly from docking port 240. The earpiece 234 is positioned appropriately on the earlobe of the user and an activation button (not shown) is engaged to switch the headset unit 220 on.

When the user is finished listening to the audio input through the headset unit 240, the activation button (not shown) is engaged to switch the headset unit 220 off. The headset unit 220 is then re-inserted into docking port 220 as previously described. When so engaged, display unit 230 may be connected to headset unit 220 in such a manner that a speaker system (not shown) in display unit 230 receives signals that have been initially received by hands-free headset unit 220 and transmitted thereby to the display unit 230 to amplify the same. This will permit the user to hear the audio output through speakers in the display unit 230 instead of through headset unit 220.

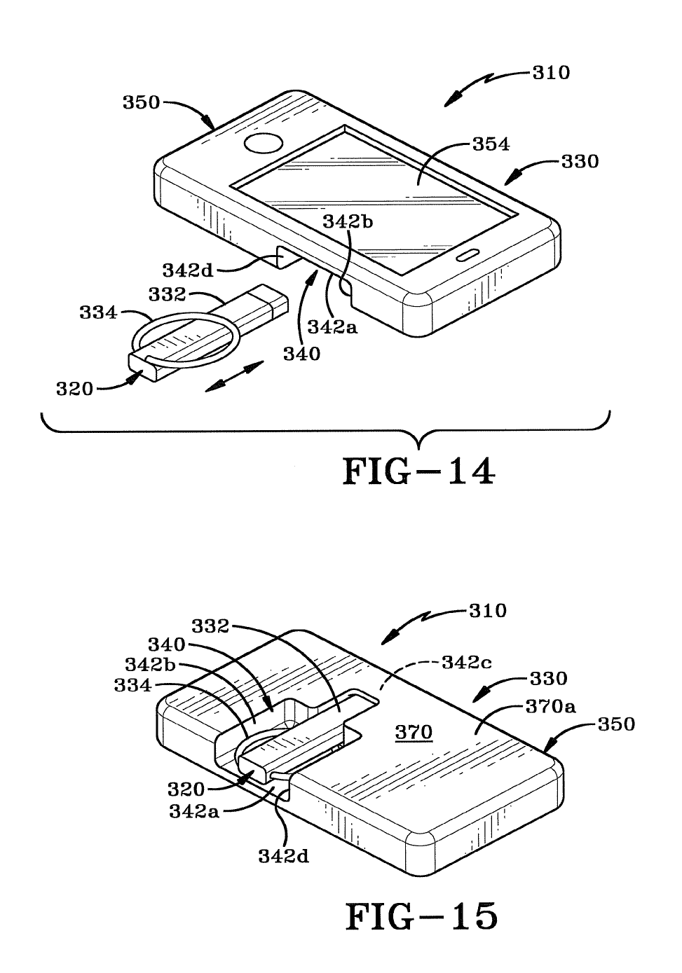

FIGS. 14 and 15 show another embodiment of a computing, communication and entertainment device in accordance with the present invention and generally indicated at 310. Device 310 utilizes a second embodiment of a display unit 330 that has at least one docking port 340 for receiving a headset unit 320 therein. In this instance, display unit 330 is a device such as a smartphone that has a housing 350 that includes a touchscreen 354 in a front surface thereof. Housing 350 also includes one or more docking ports 340 therein for receiving a wireless headset unit 320, such as a Bluetooth compatible headset unit.

Preferably, docking port 340 is defined in the rear wall 370 of display unit 330 and is sufficiently recessed into rear wall 370 that headset unit 320 does not extend outwardly beyond outer surface 370a when docked in docking port 340. As with docking port 240, docking port 340 is a recessed region having a bottom wall 342a and side walls 342b, 342c, 342d. Preferably, the portion of docking port 340 opposite side wall 342c is open so that headset unit 320 may be slidably inserted therein and removed therefrom. All other features of docking port 340 are substantially identical to docking port 240. Display unit 330 is designed to act as a storage location for the headset unit 320 and simultaneously is useful for recharging the batteries of the headset unit 320 when so docked.

While the FIGS. attached hereto have illustrated two possible communication devices that include docking ports for retaining, storing and recharging a hands-free headset therein, said two devices comprising a laptop computer and a smartphone, it will be understood that docking ports can be provided on any electronic device that is capable of playing or transmitting auditory signals to hands-free headsets. For example, desktop computers could similarly be provided with such docking ports, as could MP3 players, radios, TV's etc., all without departing from the spirit and scope of the present invention.

In the foregoing description, certain terms have been used for brevity, clarity, and understanding. No unnecessary limitations are to be implied therefrom beyond the requirement of the prior art, because such terms are used for descriptive purposes and are intended to be broadly construed.

Moreover, the description and illustration of the invention is an example and the invention is not limited to the exact details shown or described.

It is believed that a mass-market acceptance can be created for combination devices that employ the headset and the host unit in readily available forms. In particular, the headset can be of the popular form having a stubby ear-bud portion and a narrow arm portion containing the microphone. Similarly, the host unit can be of a popular form such as a handheld mobile phone having a substantially recess-free docking port. Furthermore, the docking mechanism can be made such that a noticeable portion of a docked headset is visible from the front of the host unit, thereby highlighting the docked headset and enhancing the marketing and promotion of the integrated headset capability.

As described herein, at least one embodiment of a portable combination device capable of delivering music and other audio messages includes: a host unit containing a front side and a circuit for producing audio messages and wireless representative signals of the audio messages; a headset containing a circuit for receiving the wireless representative signals, playing back audio messages through an ear-bud, formed and sized to fit in a user's ear canal, and a docking mechanism for docking the headset onto the host unit such that a substantial part of the headset protrudes beyond an edge of the host unit and is visible from the front of the host unit when docked, and the docking mechanism keeps the docking port on the host unit to be substantially recess-free.

In at least one further embodiment, a combination device as described above also includes an adapter module mounted on the host unit and having the docking mechanism integrated on it.

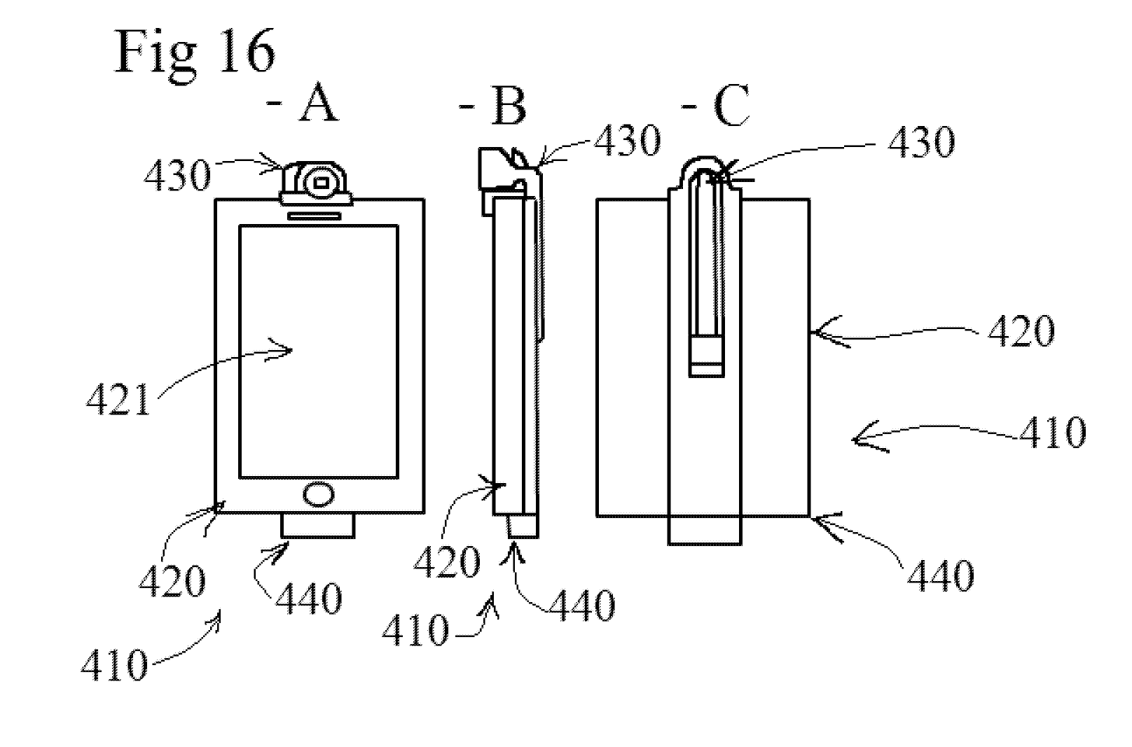

There is shown in FIGS. 16 A, B, and C, a portable combination device 10, including a host unit 420, a headset 430, and an adapter module 440. FIG. 16A also shows a display 421 visible from the front of the host unit 420.

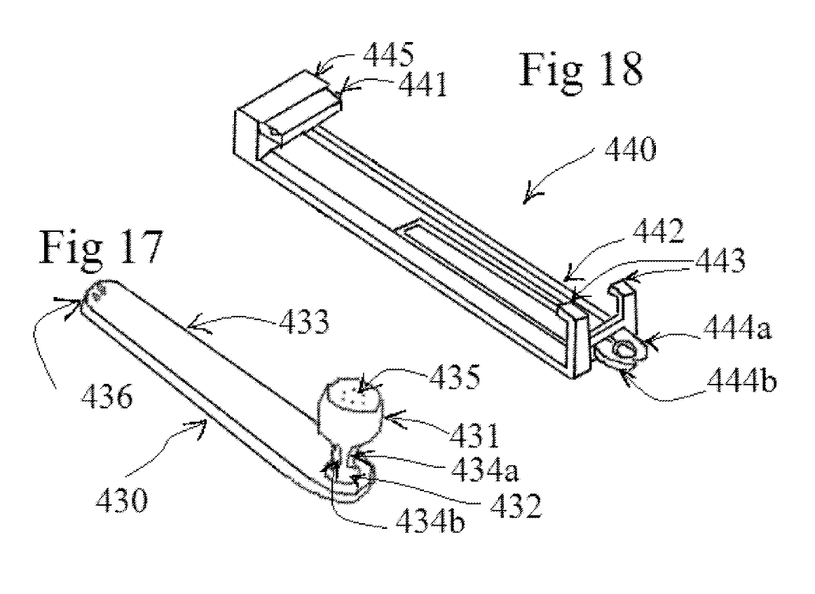

FIG. 17 shows a detailed view of the headset 430, including an ear-bud 431 having a speaker (not shown) behind speaker grill 435, for producing audio messages, and an arm 433 having a microphone (not shown) behind microphone grill 436, for picking up audio messages. The ear-bud 431, formed and sized to fit in a user's outer ear canal, connects to the headset arm 433 through a neck 432, which in turn includes charge terminals 434a and 434b. The charge terminals 434a and 434b are internally connected to an embedded battery power (not shown) of the headset 430.

FIG. 18 shows a detailed view of an adapter module 440, extending from connector end 445 to retaining end 443, supported by the main body portion 442. The docking mechanism includes headset clips 444a and 444b, constructed to fit around the neck portion 432 of headset 433, thereby securely holding the headset in place when not in use. The headset clips may be partly constructed of conductive material. The headset clips may be connected to suitable connector pins in connector 441 that carry power supply signals. Thereby, the headset 433 is charged while docked onto host unit 420.

As shown in FIGS. 16 A, B, and C, the host unit 420 is held between connector 441, which is plugged into a docking connector (not shown) of the host unit and retaining end 443. Accordingly, the headset docks onto the host unit by snapping, for example, into the headset clips 444a and 444b. The docking mechanism may position a substantial part of the headset to protrude beyond the edge of the host unit and to be visible from the front of the host unit when docked. Also, the docking mechanism may keep the docking port on the host unit to be substantially recess-free.

In an alternate embodiment, the headset clips, or other docking mechanism, may be constructed and attached to the host unit, thereby requiring no adapter module. The placement of the headset clips on the host unit may be adjusted accordingly so that a substantial part of the headset protrudes beyond the edge of the host unit so that it is visible from the front of the host unit when docked. Further, the docking mechanism may keep the docking port on the host unit substantially recess-free.

In at least one embodiment, a headset docks onto a host unit having a substantially recess-free docking port.

While principles and modes of operation have been explained and illustrated with regard to particular embodiments, it must be understood, however, that this may be practiced otherwise than as specifically explained and illustrated without departing from its spirit or scope.

1-2. (canceled)

3. A system, comprising:
a wireless headset module having a wireless headset body, the wireless headset body includes a microphone;
an ear-bud module of the wireless headset module having a neck and an ear-bud, the ear-bud includes a speaker and is mechanically coupled to the wireless headset body by the neck, the ear-bud is formed to fit into an outer portion of a user ear canal;
a housing configured to couple with at least the wireless headset module;
a docking module of the housing configured to retain at least a portion of the wireless headset body,
wherein the ear-bud extends above the docking module with the wireless headset body retained in the docking module.

4. The system of claim 3, wherein the housing is the housing of an electronic device.

5. The system of claim 3, wherein the housing is configured to attach to an electronic device.

6. The system of claim 3, further comprising one or more retaining ends configured to at least partially secure the housing to the electronic device.

7. The system of claim 6, further comprising at least one hook of the one or more retaining ends configured to wrap around at least one edge of the electronic device.

8. The system of claim 3, further comprising two or more sides of the housing, the two or more sides of the housing define a void configured to accept the at least a portion of the wireless headset body.

9. The system of claim 8, further comprising an access point including a portion of the void not filled by the at least a portion of the wireless headset body.

10. The system of claim 3, further comprising a connector end configured to connect the housing to a port of the electronic device.

11. The system of claim 10, wherein the connector end includes a connector configured to transfer at least one of power and data.

12. The system of claim 3, wherein the housing has a housing depth and a housing height, the housing depth is based at least in part on a width of the electronic device, and the housing height in based at least in part on the height of the electronic device.

13. The system of claim 3, further comprising at least one clip of the docking module configured to secure the wireless headset module.

14. The system of claim 13, further comprising a clip charging contact of the at least one clip configured to transfer power to the wireless headset module.

15. The system of claim 14, further comprising a neck charging contact of the ear-bud module, the neck charging contact receives power through electrical communication with the clip charging contact.

16. An electronic device capable of delivering at least audio signals, comprising:
a host unit including a circuit for processing the at least audio signals;
a headset configured to receive the at least audio signals and output associated sound through a speaker; and
a docking mechanism of the host unit configured to accept at least a portion of the headset to place the headset in a docked position, wherein at least a portion of the headset extends beyond an edge of the host unit in the docked position.

17. The electronic device of claim 16, further comprising:
a neck of the headset that connects the speaker to a headset body at a distance in a direction substantially normal to the headset body;
a clip of the docking mechanism configured to secure the neck of the headset and retain the headset in the docked position.

18. The electronic device of claim 16, wherein the docking mechanism defines a void that accepts at least the portion of the headset in the docked position, wherein the void has a void length that is at least a length of the portion of the headset, wherein the void has a void width that is at least a width of the portion of the headset, and wherein the void has a void depth that is less than a thickness of the headset.

19. An attachment apparatus for an electronic device capable of delivering at least audio signals, comprising:
attachment apparatus body having at least a docking recess, the docking recess having a depth;
a connector end of the adaptor module body configured to mechanically couple with a first side of an electronic device;
a connector of the connector end configured to electrically couple with the electronic device;
a retaining end of the attachment apparatus body configured to mechanically couple with a second side of the electronic device; and
a headset including a substantially planar body portion, the headset configured to dock with the docking recess of the attachment apparatus, the body portion having a width thicker than depth of the docking recess.

20. The attachment apparatus of claim 19 further comprising an ear-bud portion of the headset, wherein the ear-bud portion of the headset extends beyond the first side of the electronic device in a docked position.

21. The attachment apparatus of claim 19, further comprising:
adapter charging contacts of the retaining end in electrical communication with the connector; and
headset charging contacts of the headset configured to mate with the adapter charging contacts, the headset charging contacts place the headset in a docked position in electrical communication with the electronic device.

22. The attachment apparatus of claim 21, further comprising a neck connecting an ear-bud to the substantially planar body portion, the headset charging contacts are disposed about the neck.
